(19) United States
(12) Patent Application Publication
(10) Pub. No.: US 2012/0017488 A1
(43) Pub. Date: Jan. 26, 2012

(54) Modular Hook System

(76) Inventor: David E. Partridge, Defuniak Springs, FL (US)

(21) Appl. No.: 12/842,553

(22) Filed: Jul. 23, 2010

(51) Int. Cl. A01K 85/02

(52) U.S. Cl. 43/42.36; 43/42.05; 43/42.43; 43/42.42

(57) ABSTRACT

A modular hook and lure system. The lure body includes a central passage running parallel to its longitudinal axis. The central passage passes completely through the lure body from its forward end to its aft end. The forward portion of the passage is a leader bore which is made large enough to accommodate the leader but not the hook. The aft portion of the passage opens into a hook bore, which can accommodate the eye and shank portion of a hook. The leader is passed completely through the passage and out the aft end of the lure body. It is then attached to a hook. The eye and shank portion of the hook is then pulled within the hook bore, so that only a portion of the hook extends beyond the lure body. A weed guard is attached to the body, with a free end of the weed guard extending out to the position of a hook tip, so that the free end of the weed guard may be engaged with the hook tip.

### CROSS-REFERENCES TO RELATED APPLICATIONS

Not applicable.

### STATEMENT REGARDING FEDERALLY SPONSORED RESEARCH OR DEVELOPMENT

Not Applicable

### MICROFICHE APPENDIX

Not Applicable

### BACKGROUND OF THE INVENTION

1. Field of the Invention

This invention relates to the field of sporting goods. More specifically the invention comprises a modular hook and lure system in which a substantial portion of the hook is contained within the lure until a fish strikes the lure.

2. Description of the Related Art

Artificial fishing hires have been in common use for many years. FIG. 1 shows a representative example. Lure 10 is attached to leader 12 (a short length of reinforced line proximate the hook). The attachment is often made by tying the leader's free end to eye 16 on the forward portion of body 14. Hook hanger 18 is located on the body's aft end. Treble hook 20 is attached hook hanger 18.

It is common to attach a second treble hook using a second hook hanger located along the ventral portion of body 14. Decoration 22 is added to the body to make it more closely resemble a live bait fish. The decoration often includes eyes, gill slits, and textural elements designed to mimic the reflectivity of fish scales.

The overall objective of the design is to closely mimic a bait fish species. The body and its associated decorations do this well. However, the prior art approach to attaching hook assemblies can spoil the overall presentation of the lure. The hook assemblies do not resemble the appearance or action of a bait fish. Rather, they hang loosely outside body 14 and may spoil the overall effect. It is therefore desirable to provide a hook assembly which can eliminate this problem.

Those skilled in the art will know that many different hook designs are presently available. Traditional treble hooks have three hooks of equal length. FIG. 2 shows a more modern design, designated as treble hook 20. The treble hook is attached using eye 24, as for the older designs. Shank 26 branches into three hooks. Large hook 28 is longer and larger than the two small hooks 30. Each of the three hooks contains a tip 34 and barb 36. This type of treble hook works particularly well in the inventive design, though the inventive design is by no means limited to any one type of hook.

### BRIEF SUMMARY OF THE INVENTION

The present invention comprises a modular hook and lure system. The hire body includes a central passage running parallel to its longitudinal axis. The central passage passes completely through the lure body from its forward end to its aft end. The forward portion of the passage is a leader bore which is made large enough to accommodate the leader. The aft portion of the passage opens into a hook bore, which can accommodate the eye and shank portion of a hook.

The leader is passed completely through the passage and out the aft end of the lure body. It is then attached to a hook. The eye and shank portion of the hook is then pulled within the hook bore, so that only a portion of the hook extends beyond the lure body. A weed guard is attached to the body, with a free end of the weed guard extending out to the position of a hook tip, so that the free end of the weed guard may be engaged with the hook tip. When so engaged, the spring force of the weed guard acting on the tip tends to retain the hook within the lure body.

When a fish strikes the lure and the hook is set, the hook will be pulled free of the lure body and it will thereafter function in a conventional fashion. In the case of a treble hook, three weed guards may be provided on the lure body to engage all three hook tips. A magnet may optionally be placed within the lure body to provide an additional force tending to retain the hook in the lure body.

### BRIEF DESCRIPTION OF THE SEVERAL VIEWS OF THE DRAWINGS

FIG. 1 is a perspective view, showing a prior art lure.

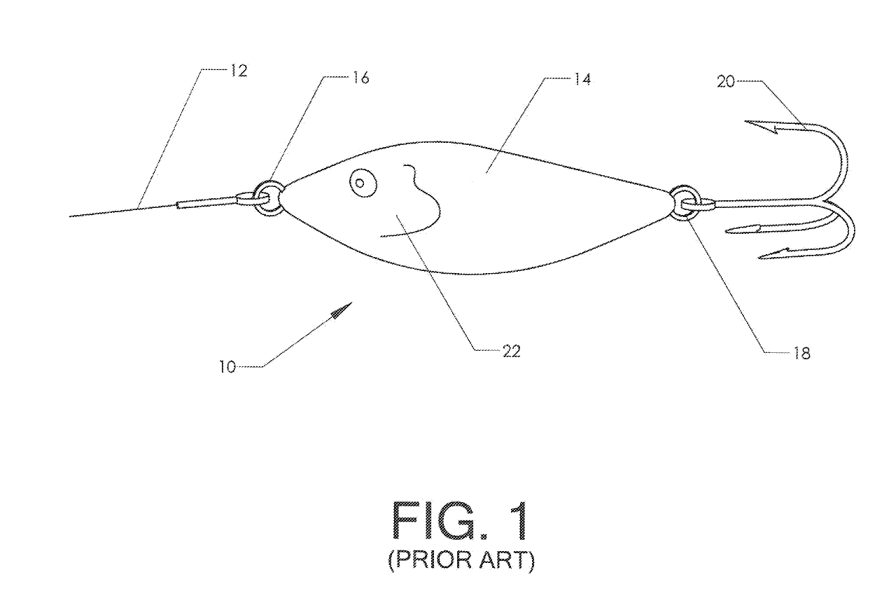

FIG. 2 is a perspective view, showing a prior art treble hook.

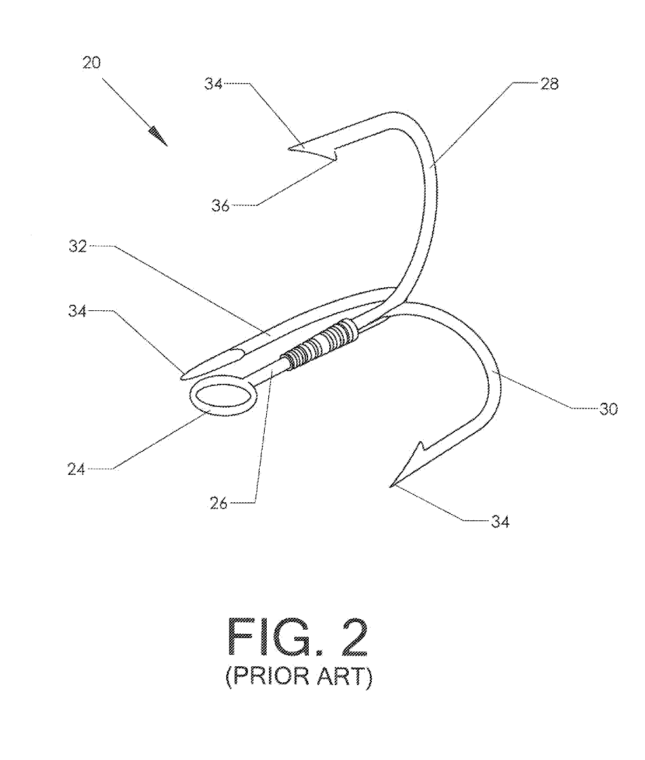

FIG. 3 is a perspective view with hidden lines, showing the internal passage through the lure body.

FIG. 4 is a perspective view with hidden lines, showing the operation of the invention.

FIG. 5 is a perspective view with hidden lines, showing the hook stowed in the lure body.

FIG. 6 is a sectioned elevation view, showing the hook stowed in the lure body.

FIG. 7 is a detailed perspective view, showing the aft end of the lure body.

FIG. 8 is a perspective view with hidden lines, showing an alternate embodiment.

REFERENCE NUMERALS IN THE DRAWINGS

| | | | |
|---|---|---|---|
| 10 | lure | 12 | leader |
| 14 | body | 16 | eye |
| 18 | hook hanger | 20 | treble hook |
| 22 | decoration | 24 | eye |
| 26 | shank | 28 | large hook |
| 30 | small hook | 32 | small hook |
| 34 | tip | 36 | barb |
| 38 | leader opening | 40 | axis |
| 42 | leader bore | 44 | hook bore |
| 46 | shoulder | 48 | dorsal slot |
| 50 | lateral slot | 52 | dorsal weed guard |
| 54 | lateral weed guard | 56 | magnet |
| 58 | forward end | 60 | aft end |
| 62 | dorsal hook slot | 64 | hook |
| 68 | top water body | | |

### DETAILED DESCRIPTION OF THE INVENTION

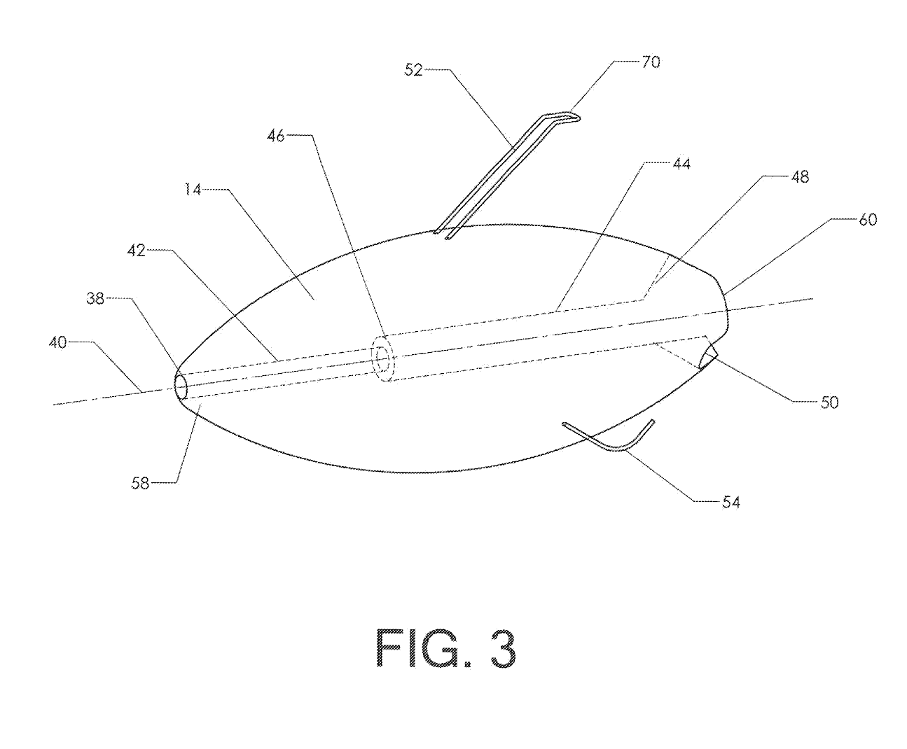

FIG. 3 shows a lure body made according to the present invention. Body 14 is preferably made in an elongated shape mimicking the body of a suitable bait fish. External decorations, such as eye and gill patterns, can be added as for the prior art. A passage extends through the lure body along axis 40. The passage extends from forward end 58 all the way to aft end 60.

Leader opening 38 is located on forward end 58. The fishing line or leader is passed through this opening and into the internal passage. In the embodiment shown, the passage has two distinct portions. Leader bore 42 is located near the body's forward end while hook bore 44 is located near the aft end. Hook bore 44 is substantially larger than leader bore 38, with the two joining at shoulder 46. The term “bore” should not be understood to limit the internal passage to circular cross sections. However, the embodiment shown does use circular cross sections.

Hook bore 44 is sized to admit eye 24 of a hook such as treble hook 20. Leader bore 42 is preferably made small enough to prevent the entrance of the hook eye into this portion of the passage (though this need not be the case for every embodiment).

Dorsal weed guard 52 is preferably made of spring wire. Its first end is attached to body 14 while its free end is formed into loop 70—the purpose of which will be explained subsequently. One or more lateral weed guards 54 may also be provided. One or more slots in the aft end of the body may be provided as well, such as dorsal slot 48 and lateral slot 50.

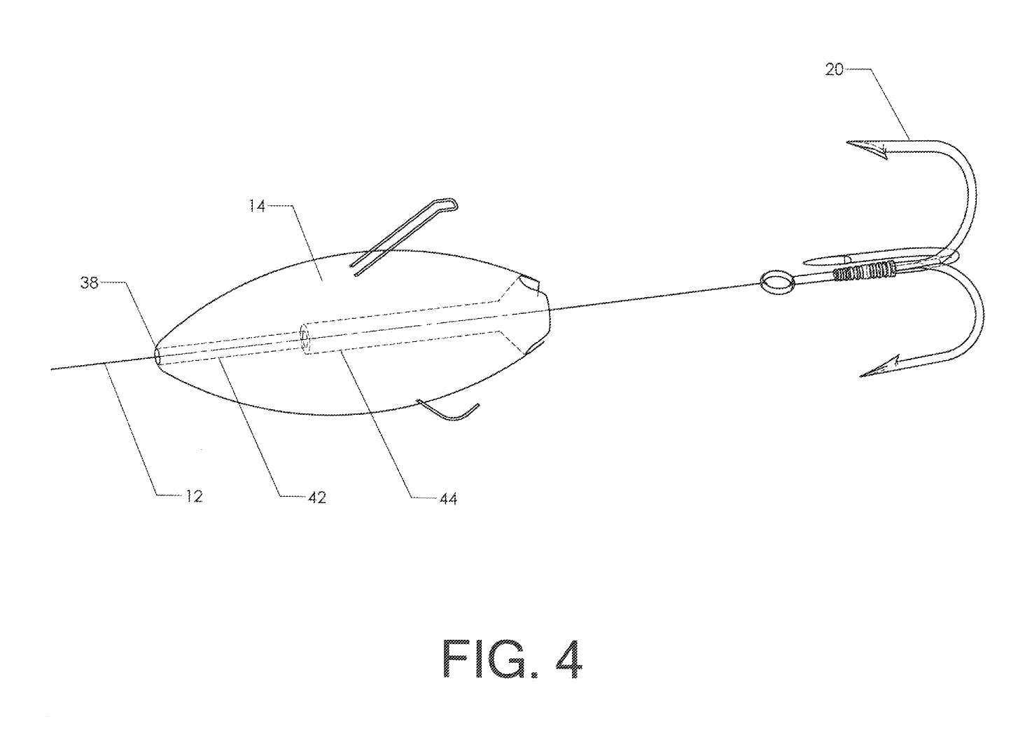

FIG. 4 shows lure body 14 assembled with a leader 12 and treble hook 20. The reader will note that the leader has been threaded through the passage through the lure body (leader bore 42 and hook bore 44) prior to being attached to treble hook 20. Those skilled in the art will know that a leader may or may not be present. The fishing line itself may simply be connected to treble hook 20 after being passed through the lure body. However, most anglers will prefer to use a leader for the last portion of the line leading up to the treble hook—and this is what has been illustrated in the figures.

In the configuration shown in FIG. 4, the user can advance body 14 toward treble hook 20. Hook bore 44 is designed to receive the eye and at least a portion of the shank of the treble hook so that the treble hook becomes partially stowed within the lure body.

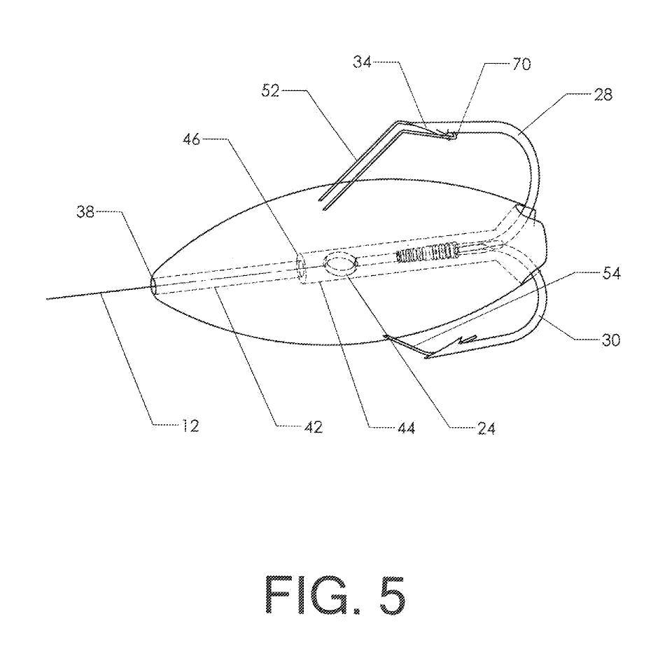

FIG. 5 shows the treble hook after it has been secured within the lure body. In this embodiment, eye 24 and the entire shank is accommodated within hook bore 44. Placing tension on leader 12 will in fact pull eye 24 against shoulder 46. This is the desired configuration, as the treble hook is much more concealed. The hook tips also move with the lure body in a more natural fashion.

In the course of fishing tension will not always be placed on the leader. At those times the treble hook will tend to slide out the back of the lure body. In order to prevent this motion, dorsal weed guard 52 is engaged with tip 34 of large hook 28. The weed guard can assume many forms. In this example, it contains a loop 70 which is passed around tip 34.

Dorsal weed guard 52 is preferably made of spring wire. It is positioned and oriented so that it ‘must be forced inward toward the lure body in order to place loop 70 around tip 34. Once the loop is in position, the restoring spring force of the weed guard tends to urge tip 34 upward. This force tends to “cock” the shank of the hook within hook bore 44, which increases the frictional engagement between the eye/shank and the walls of hook bore 44. This frictional engagement prevents the treble hook from backing out of the lure body (unless struck by a fish). The loop may also be positioned to slip behind the barb on the hook point, thereby further enhancing the engagement. Dorsal and lateral slots are provided in the aft end of the lure body to allow the treble hook to slide further into the lure body.

The two remaining hooks of the treble hook protrude laterally (one per side). Lateral weed guards 54 may be provided to engage these additional hook tips if desired. A single weed guard will provide the force needed to retain the hook in the stowed position. However, if the angler intends to cast the lure into weeds or other debris, it is preferable to have a weed guard for each hook point.

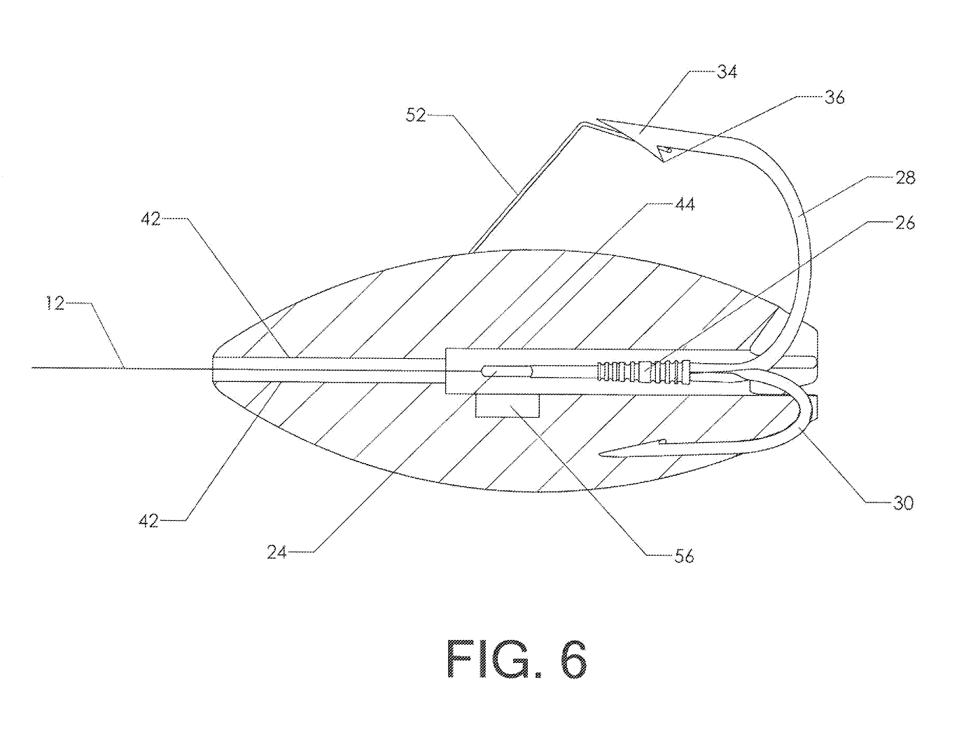

FIG. 6 shows a sectional elevation view through the lure body with the treble hook in the stowed position. The reader may easily perceive how the upward force exerted by dorsal weed guard 52 on tip 34 of large hook 28 tends to “cock” eye 24 and shank 26 with respect to the hook bore. Magnet 56 is optionally added to further increase the retention force. The magnet tends to attract the larger metal mass found in eye 24, thereby retaining the treble hook in the stowed position.

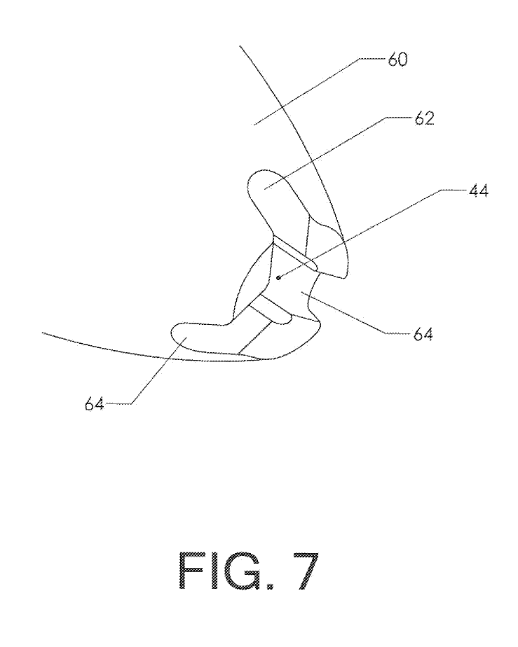

FIG. 7 shows detail of the aft end 60 of the lure body. Slots may be positioned to receive the branching portion of each of the three hooks of a treble hook. Dorsal hook slot 48 is positioned to receive the portion of large hook 28 which lies next to the hook shank. Lateral slots 50 are positioned to receive the two small hooks 30 of the treble hook.

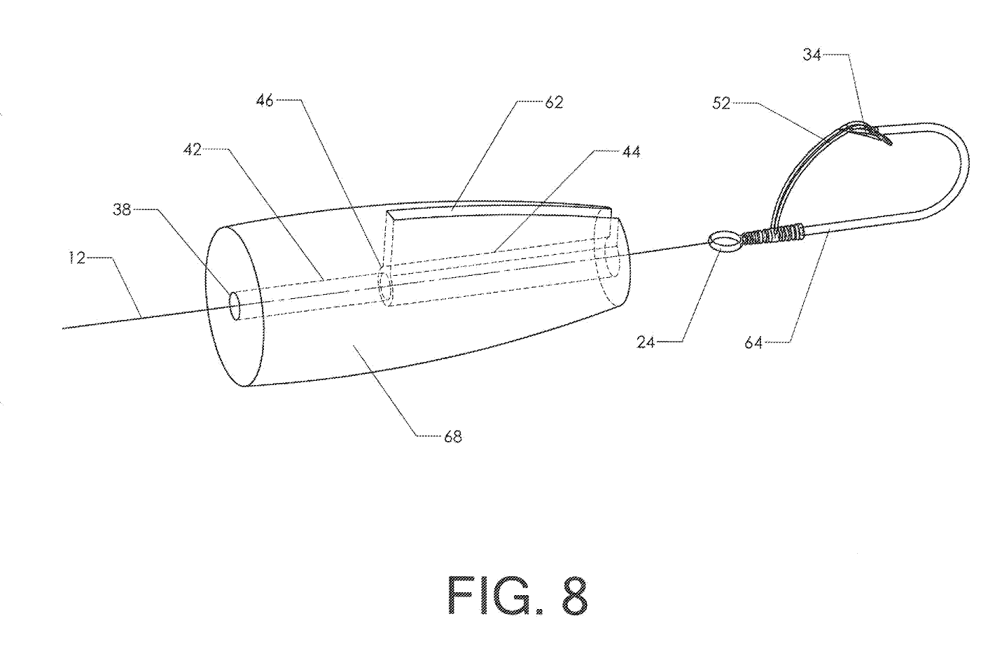

FIG. 8 shows an alternate embodiment configured for use as a “top water” bait. Top water body 68 contains the same internal passage having leader bore 42, hook bore 44, and shoulder 46. However, the top water bait is designed for use with hook 64 which only has a single tip 34. Dorsal weed guard 52 is directly attached to the hook shank near eye 24.

Dorsal hook slot 62 is elongated in order to allow the hook eye with its incorporated dorsal weed guard 52 to slide into the lure body. Since the weed guard does not “cock” the hook with respect to the body, this embodiment preferably includes a magnet positioned to attract eye 24 when it is in the stowed position.

In all the embodiments the hook is designed to remain partially stowed within the lure until a fish strikes the lure. The retention mechanism is provided to keep the hook in the stowed position. However, the retention force must not be so great that it prevents the hook coming free when a fish actually strikes the lure.

When a fish strikes the lure and the angler sets the hook, the hook will remain in the fish's mouth while the lure body slides forward along the leader. The configuration will then he as shown in FIG. 4. As the fish struggles it tends to jerk its head from side to side. A hook that remains attached to the lure body allows the fish to use the lure body itself as leverage to remove the hook. In the present design the body will slide away from the hook and it will not tend to inadvertently dislodge the hook from the fish's mouth.

The invention can be used with a wide variety of materials and known combinations of angling equipment. The lure body can be made of a buoyant material so that it floats as a top water bait. The lure body may also be made of a heavier material so that it easily sinks to trolling depths or lower.

The preceding description contains significant detail regarding the novel aspects of the present invention. It should not be construed, however, as limiting the scope of the invention but rather as providing illustrations of the preferred embodiments of the invention. Thus, the scope of the invention should be fixed by the following claims, rather than by the examples given.

Having described my invention, I claim:

1. A fishing lure assembly, comprising:
a. a lure body having a forward end and an aft end;
b. said lure body including a passage from said forward end to said aft end, with said passage commencing at a leader opening at said forward end;
c. a hook, including an eye, a shank, and at least one tip;
d. said passage including a leader bore in said forward end of said lure body, a hook bore in said aft end of said lure body, and a shoulder formed by the junction between said leader bore and said hook bore;
e. wherein said hook bore is large enough to accommodate said eye but said leader bore is not large enough to accommodate said eye;
f. said eye of said hook being placed proximate said shoulder in said passage; and
g. said lure body including a weed guard having a first end attached to said lure body and a second free end, with said free end being positioned to engage said at least one tip on said hook.

2. A fishing lure assembly as recited in claim 1, wherein said free end of said weed guard includes a loop sized to loop around said at least one tip on said hook, thereby engaging said free end of said weed guard to said at least one tip.

3. A fishing lure assembly as recited in claim 1, wherein said weed guard is positioned to cock said hook with respect to said lure body, thereby frictionally engaging said shank with said hook bore.

4. A fishing lure assembly as recited in claim 1, further comprising a magnet in said lure body proximate said shoulder in said passage.

5. A fishing lure assembly as recited in claim 1, wherein:
a. said hook includes a second tip;
b. said lure body includes a second weed guard having a first end attached to said lure body and a second free end positioned to engage said second tip.

6. A fishing lure assembly as recited in claim 1, wherein said aft end of said lure body includes a dorsal slot sized to accommodate a portion of said hook.

7. A fishing lure assembly as recited in claim 5, wherein said aft end of said lure body includes a lateral slot sized to accommodate a portion of said hook.

8. A fishing lure assembly, comprising:
a. a lure body having a forward end and an aft end;
b. said lure body including a passage from said forward end to said aft end, with said passage including a relatively small leader bore portion proximate said forward end, a relatively large hook bore portion proximate said aft end, and a shoulder therebetween;
c. a hook, including an eye, a shank, and three tips;
d. said hook bore being large enough to accommodate said eye but said leader bore being too small to accommodate said eye;
e. said eye and at least a portion of said shank being placed in said passage with said eye proximate said shoulder; and
f. a weed guard having a first end and a second end, with said first end being attached to said lure body and said second end being engaging one of said three tips of said hook.

9. A fishing lure assembly as recited in claim 8, wherein said second end of said weed guard includes a loop sized to loop around said one of said three tips, thereby engaging said second end of said weed guard to said tip.

10. A fishing lure assembly as recited in claim 8, wherein said weed guard is positioned so that said weed guard tends to cock said hook with respect to said lure body, thereby frictionally engaging said shank with said hook bore.

11. A fishing lure assembly as recited in claim 8, further comprising a magnet in said lure body proximate said shoulder in said passage.

12. A fishing lure assembly as recited in claim 8, wherein said lure body includes a second weed guard having a first end attached to said lure body and a second free end engaging said second tip of said three tips.

13. A fishing lure assembly as recited in claim 8, wherein said aft end of said lure body includes a dorsal slot sized to accommodate a portion of said hook.

14. A fishing lure assembly as recited in claim 8, wherein said aft end of said lure body includes a lateral slot sized to accommodate a portion of said hook.

15. A fishing lure assembly, comprising:
a. a lure body having a forward end and an aft end;
b. a hook, including an eye, a shank, and at least one tip;
c. said lure body including a passage from said forward end to said aft end, wherein at least a portion of said passage is large enough to accommodate said eye;
d. said eye and at least a portion of said shank being placed within said passage;
e. said aft end of said lure body including a slot sized to accommodate a portion of said hook;
f. a portion of said hook being placed within said slot in said aft end of said lure body; and
g. a weed guard having a first end and a second end, with said first end being attached to said lure body and said second end being engaged with said tip.

16. A fishing lure assembly as recited in claim 15, wherein said free end of said weed guard includes a loop sized to loop around said at least one tip on said hook, thereby engaging said free end of said weed guard to said at least one tip.

17. A fishing lure assembly as recited in claim 15, wherein said weed guard is positioned to cock said hook with respect to said lure body, thereby frictionally engaging said shank with said hook bore.

18. A fishing lure assembly as recited in claim 15, further comprising a magnet in said lure body proximate said shoulder in said passage.

19. A fishing lure assembly as recited in claim 15, wherein:
a. said hook includes a second tip;
b. said lure body includes a second weed guard having a first end attached to said lure body and a second free end engaged to said second tip.

20. A fishing lure assembly as recited in claim 15, wherein said aft end of said lure body includes a dorsal slot sized to accommodate a portion of said hook.
